(19) United States
(12) Patent Application Publication
(10) Pub. No.: US 2024/0266893 A1
(43) Pub. Date: Aug. 8, 2024

(54) ROTOR FOR ROTARY ELECTRIC MACHINE, AND ROTARY ELECTRIC MACHINE

(71) Applicant: HITACHI ASTEMO, LTD., Hitachinaka-shi, Ibaraki (JP)

(72) Inventors: Yuji KOBAYASHI, Hitachinaka-shi (JP); Yasuyuki SAITO, Hitachinaka-shi (JP); Miku TAKAHASHI, Hitachinaka-shi (JP); Hiroki NARUSHIMA, Hitachinaka-shi (JP)

(73) Assignee: HITACHI ASTEMO, LTD., Hitachinaka-shi, Ibaraki (JP)

(21) Appl. No.: 18/564,164

(22) PCT Filed: Aug. 27, 2021
(86) PCT No.: PCT/JP2021/031616

§ 371 Date: Nov. 27, 2023

(51) Int. Cl. H02K 1/276; B60K 6/26; H02K 29/03

(52) U.S. Cl. CPC H02K 1/276; B60K 6/26; B60Y 2200/92; B60Y 2400/60; H02K 29/03

(57) ABSTRACT

A rotor for a rotary electric machine, and a rotary electric machine using the same include a pair of first magnets arranged in a V shape, and a pair of second magnets, magnet holes are provided with a first magnetic vacancy facing a d-axis with the first magnet interposed therebetween, and a second magnetic vacancy facing the d-axis with the second magnet interposed therebetween, the distance from the d-axis to an end portion of the first magnetic vacancy is made larger than the distance from the d-axis to an end portion of the second magnet in an outermost diameter side when viewed in a direction perpendicular to the d-axis, the distance between the first magnetic vacancy and the second magnetic vacancy in an outermost diameter side is smaller than the distance between the second magnetic vacancies adjacent to each other in a plurality of magnetic poles, and the V-shape formed by the pair of first magnets has an inside angle with a magnitude which is larger than that of the inside angle formed by the pair of second magnets.

### TECHNICAL FIELD

The present invention relates to rotors for rotary electric machines, and rotary electric machines using the same.

### BACKGROUND ART

As a background art of the present invention, in order to reduce cogging torques and torque ripples in permanent magnet motors mounted on automobiles and the like, for reducing latent NVH (Noise, Vibration and Harshness) problems, PTL 1 cited below discloses a rotor using magnets in two layers in a laminated-layer stack, wherein an inner layer is disposed near a rotor and is constituted by larger magnets, and an outer layer is disposed near an outer laminated-layer stack surface and is constituted by smaller magnets.

### CITATION LIST

### Patent Literature

PTL 1: JP 2020-68654 A

### SUMMARY OF INVENTION

### Technical Problem

Based on the structure of PTL 1, it is necessary to further improve the NV performance while maintaining the output performance in order to meet customer requirements. Therefore, it is an object of the present invention to provide a rotor for a rotary electric machine which is capable of generating higher outputs while reducing torque ripples.

### Solution to Problem

There is provided a rotor for a rotary electric machine, wherein the rotor includes magnets, and magnet holes in which the magnets are inserted. The magnets include a pair of first magnets arranged in a V shape, and a pair of second magnets arranged in a V shape in a radially inner side with respect to the first magnets. The magnet holes are provided with a first magnetic vacancy facing a d-axis with the first magnet interposed therebetween, and a second magnetic vacancy facing the d-axis with the second magnet interposed therebetween. The distance from the d-axis to an end portion of the first magnetic vacancy is made larger than the distance from the d-axis to an end portion of the second magnet in an outermost diameter side when viewed in a direction perpendicular to the d-axis. In an outermost diameter side, the distance between the first magnetic vacancy and the second magnetic vacancy is smaller than the distance between the second magnetic vacancies adjacent to each other in a plurality of magnetic poles. The V-shape formed by the pair of first magnets has an inside angle with a magnitude which is larger than the magnitude of an inside angle of the V-shape formed by the pair of second magnets.

### Advantageous Effects of Invention

According to the present invention, it is possible to provide a rotor for a rotary electric machine which is capable of generating higher outputs while reducing torque ripples.

### BRIEF DESCRIPTION OF DRAWINGS

FIG. 1 is a block diagram of a vehicle according to an embodiment of the present invention.

FIG. 2 is an electric circuit diagram of a power conversion device in FIG. 1.

FIG. 3 is a cross-sectional view of a rotary electric machine in FIG. 1.

FIG. 4 is a cross-sectional view of a rotor core and a stator core, taken along the line A-A in FIG. 3.

FIG. 5 is a partially enlarged view of a rotor for a rotary electric machine according to an embodiment of the present invention.

FIG. 6 is a view for explaining effects of the invention, according to an embodiment of the present invention.

FIG. 7 is a view for explaining effects of the invention, according to an embodiment of the present invention.

FIG. 8 is a view for explaining effects of the invention, according to an embodiment of the present invention.

FIG. 9 is a view for explaining effects of the invention, according to an embodiment of the present invention.

FIG. 10 is a first modification example of the present invention.

FIG. 11 is second and third modification examples of the present invention.

FIG. 12A is a fourth modification example of the present invention.

FIG. 12B is a fifth modification example of the present invention.

FIG. 12C is a sixth modification example of the present invention.

FIG. 13 is seventh and eighth modification examples of the present invention.

FIG. 14 is ninth and tenth modification examples of the present invention.

Hereinafter, an embodiment of the present invention will be described with reference to the drawings. The following description and drawings are merely examples for explaining the present invention, and omission and simplification are made thereto appropriately for the sake of clarification of explanation. The present invention can be also implemented in other various aspects. Unless otherwise specified, as each constituent component, it is possible to provide one or plural such constituent components.

The position, the size, the shape, the range and the like of each constituent component illustrated in the drawings may not express its actual position, size, shape, range and the like, in order to facilitate understanding of the invention, in some cases. Therefore, the present invention is not necessarily limited to the positions, sizes, shapes, ranges and the like disclosed in the drawings.

### One Embodiment and an Overall Structure of the Present Invention

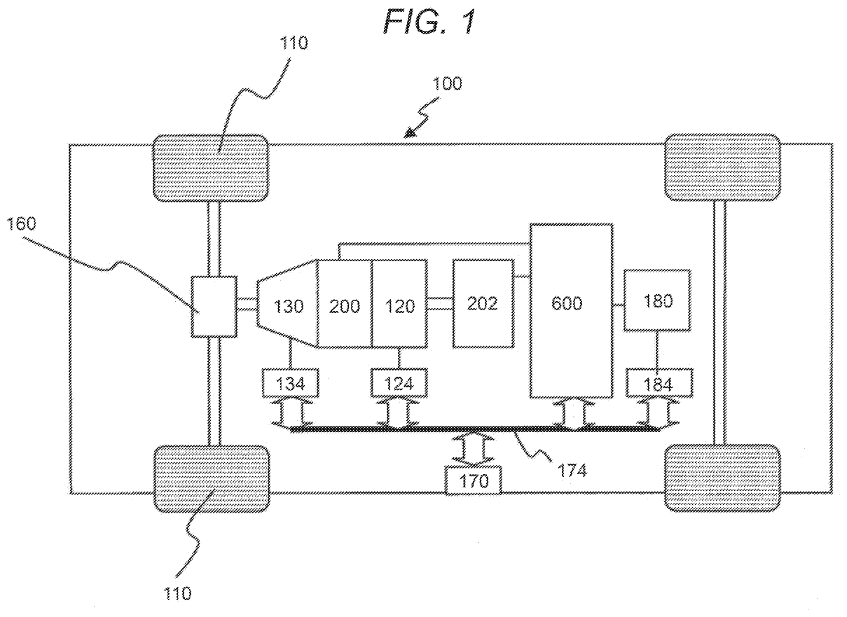

FIG. 1 is a view illustrating a general structure of a hybrid-type electric vehicle equipped with a rotary electric machine according to one embodiment of the present invention.

An engine 120, a first rotary electric machine 200, a second rotary electric machine 202, and a battery 180 are mounted on a vehicle 100. When driving force from the rotary electric machines 200, 202 is required, the battery 180 supplies DC power to the rotary electric machines 200, 202 through a power conversion device 600. During regenerative traveling, the battery 180 receives DC power from the rotary electric machines 200, 202 on the contrary. The battery 180 supplies and receives DC power to and from the rotary electric machines 200, 202 through the power conversion device 600.

The rotating torque generated by the engine 120 and the rotary electric machines 200, 202 is transmitted to front wheels 110 through a transmission 130 and a differential gear 160. The transmission 130 is controlled by a transmission control device 134, and the engine 120 is controlled by an engine control device 124. The battery 180 is controlled by a battery control device 184. The transmission control device 134, the engine control device 124, the battery control device 184, the power conversion device 600, and an integrated control device 170 are connected to each other through a communication line 174.

The integrated control device 170 is a control device at a higher rank than those of the transmission control device 134, the engine control device 124, the power conversion device 600, and the battery control device 184. The integrated control device 170 receives information indicating respective states of the transmission control device 134, the engine control device 124, the power conversion device 600, and the battery control device 184 through the communication line 174. The integrated control device 170 calculates commands for controlling the respective control devices, based on the acquired information. The calculated control commands are transmitted to the respective control devices through the communication line 174.

The high-voltage battery 180 is constituted by a secondary battery such as a lithium ion battery or a nickel hydrogen battery, and outputs DC power with a high voltage of 250 V to 600 V or higher there than. Further, although not illustrated, in the vehicle 100, there is mounted a battery for supplying power with a low voltage (for example, 14-volt base power), and this battery supplies DC power to control circuits.

The battery control device 184 outputs a charging/discharging status of the battery 180 and states of respective unit cell batteries constituting the battery 180, to the integrated control device 170, through the communication line 174. If the integrated control device 170 determines that it is necessary to charge the battery 180 based on the information from the battery control device 184, the integrated control device 170 instructs the power conversion device 600 to perform a power generating operation.

Further, the integrated control device 170 mainly performs management of output torques from the engine 120 and the rotary electric machines 200, 202, and processing for calculating an integrated torque which is the sum of the output torque from the engine 120 and the output torques from the rotary electric machines 200, 202, and a torque distribution ratio therebetween. Further, the integrated control device 170 transmits control commands based on the result of the calculation processing, to the transmission control device 134, the engine control device 124, and the power conversion device 600. Based on a torque command from the integrated control device 170, the power conversion device 600 controls the rotary electric machines 200, 202 in such a way as to generate torque outputs or generated power, according to the command.

The power conversion device 600 is provided with power semiconductor elements constituting an inverter for operating the rotary electric machines 200, 202. The power conversion device 600 controls switching operations of the power semiconductor elements, based on commands from the integrated control device 170. Through the switching operations of the power semiconductor elements, the rotary electric machines 200, 202 are operated as electric motors or generators.

When the rotary electric machines 200, 202 are operated as electric motors, DC power from the high-voltage battery 180 is supplied to DC terminals in the inverter in the power conversion device 600. The power conversion device 600 controls the switching operations of the power semiconductor elements to convert the supplied DC power into three-phase AC power. Further, the power conversion device 600 supplies the three-phase AC power to the rotary electric machines 200, 202. On the other hand, when the rotary electric machines 200, 202 are operated as generators, the rotors in the rotary electric machines 200, 202 are driven to rotate by rotating torques applied thereto from the outside, thereby generating three-phase AC power in the stator windings in the rotary electric machines 200, 202. The generated three-phase AC power is converted into DC power by the power conversion device 600, and the DC power is supplied to the high-voltage battery 180, so that the battery 180 is charged.

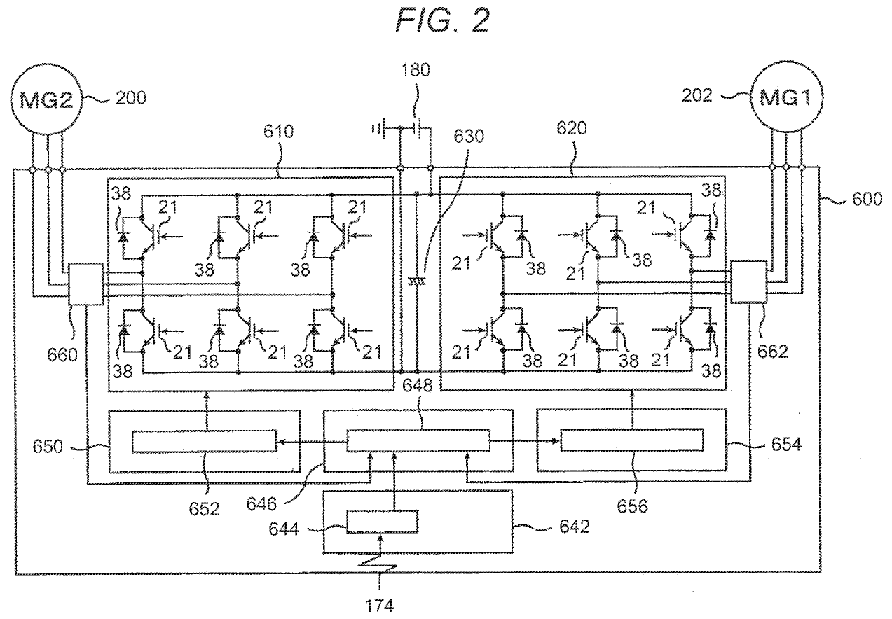

FIG. 2 is a circuit diagram of the power conversion device in FIG. 1.

The power conversion device 600 is provided with a first inverter device for the rotary electric machine 200, and a second inverter device for the rotary electric machine 202. The first inverter device includes a power module 610, a first drive circuit 652 for controlling the switching operations of respective power semiconductor elements 21 in the power module 610, and a current sensor 660 for detecting a current in the rotary electric machine 200. The drive circuit 652 is provided on a drive circuit board 650. On the other hand, the second inverter device includes a power module 620, a second drive circuit 656 for controlling the switching operations of respective power semiconductor elements 21 in the power module 620, and a current sensor 662 for detecting a current in the rotary electric machine 202. The drive circuit 656 is provided on a drive circuit board 654.

A control circuit 648 provided on a control circuit board 646, a capacitor module 630, and a transmission/reception circuit 644 mounted on a connector board 642 are used in a shared manner by the first inverter device and the second inverter device.

The power modules 610, 620 are operated by drive signals outputted from the respective corresponding drive circuits 652, 656. The power modules 610, 620 each convert DC power supplied from the battery 180 into three-phase AC power, and supply the power to the stator windings as the armature windings in the corresponding rotary electric machine 200, 202. Further, the power modules 610, 620 convert AC power induced in the stator windings in the rotary electric machines 200, 202 into DC power and supply the DC power to the high-voltage battery 180.

As illustrated in FIG. 2, the power modules 610, 620 include a three-phase bridge circuit, wherein respective series circuits corresponding to the three phases are electrically connected in parallel with each other between a positive electrode side and a negative electrode side of the battery 180. Each series circuit includes a power semiconductor element 21 constituting an upper arm, and a power semiconductor element 21 constituting a lower arm, and these power semiconductor elements 21 are connected to each other in series. The power module 610 and the power module 620 have substantially the same circuit structure as illustrated in FIG. 2, and, hereinafter, the power module 610 will be representatively described.

In the present embodiment, insulated gate bipolar transistors (IGBTs) 21 are used as the switching power semiconductor elements. Each IGBT 21 includes three electrodes, which are a collector electrode, an emitter electrode, and a gate electrode. A diode 38 is electrically connected between the collector electrode and the emitter electrode in each IGBT 21. The diode 38 includes two electrodes as a cathode electrode and an anode electrode, and the cathode electrode is electrically connected to the collector electrode of the IGBT 21, and the anode electrode is electrically connected to the emitter electrode of the IGBT 21 so that the direction from the emitter electrode to the collector electrode of the IGBT 21 is the forward direction.

Also, MOSFETs (metal-oxide-semiconductor field-effect transistors) may be used, as the switching power semiconductor elements. A MOSFET includes three electrodes, which are a drain electrode, a source electrode, and a gate electrode. Such a MOSFET includes a parasitic diode between the source electrode and the drain electrode, such that the direction from the drain electrode to the source electrode is the forward direction, which eliminates the necessity of providing the diodes 38 in FIG. 2.

The arm of each phase is structured by electrically connecting the emitter electrode of an IGBT 21 and the collector electrode of an IGBT 21 to each other in series. Incidentally, although, in the present embodiment, there is illustrated only one IGBT in each of the upper and lower arms of each phase, a plurality of IGBTs is electrically connected thereto in parallel with each other in actual, since a large current capacity should be controlled. Hereinafter, one power semiconductor element will be described, for simplification of description.

In the example illustrated in FIG. 2, the upper arms or the lower arms of the respective phases include three IGBTs. The IGBTs 21 in the upper arms of the respective phases are electrically connected, at their collector electrodes to the positive electrode side of the battery 180, while the IGBTs 21 in the lower arms of the respective phases are electrically connected, at their source electrodes, to the negative electrode side of the battery 180. The arms of each phase are electrically connected, at a mid point (a connection portion between the emitter electrode of the IGBT in the upper arm and the collector electrode of the IGBT in the lower arm), to the armature winding (the stator winding) of the corresponding phase in the corresponding rotary electric machine 200, 202.

The drive circuits 652, 656 constitute drive units for controlling the respective corresponding inverter devices 610, 620, and generate drive signals for driving the IGBTs 21 based on control signals outputted from the control circuit 648. The drive signals generated from the respective drive circuits 652, 656 are outputted to the gates of the respective power semiconductor elements in the respective corresponding power modules 610, 620. In each of the drive circuits 652, 656, there are provided six integrated circuits for generating drive signals to be supplied to the gates in the respective upper and lower arms of the respective phases, and the six integrated circuits are structured as a single block.

The control circuit 648 constitutes a control unit for the respective inverter devices 610, 620, and is constituted by a microcomputer for calculating control signals (control values) for operating (turning on and off) the plurality of switching power semiconductor elements. Torque command signals (torque command values) from a higher-ranking control device, sensor outputs from the current sensors 660, 662, and sensor outputs from rotation sensors mounted on the rotary electric machines 200, 202 are inputted to the control circuit 648. The control circuit 648 calculates control values based on these input signals, and outputs control signals for controlling the switching timings to the drive circuits 652, 656.

The transmission/reception circuit 644 mounted on the connector board 642 is for electrically connecting the power conversion device 600 and an external control device to each other, and transmits and receives information to and from the other device through the communication line 174 in FIG. 1. The capacitor module 630 constitutes a smoothing circuit for suppressing the fluctuation of the DC voltage caused by the switching operations of the IGBTs 21, and is electrically connected, in parallel, to terminals in the DC side in the first power module 610 and the second power module 620.

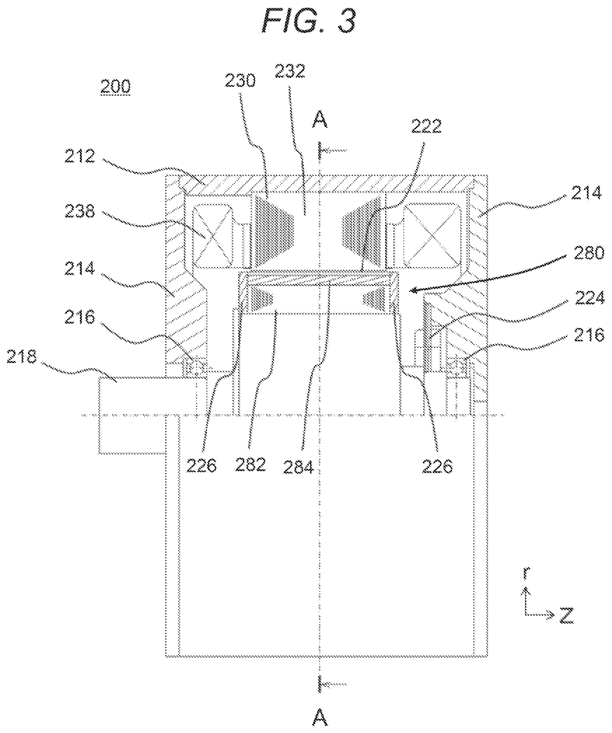

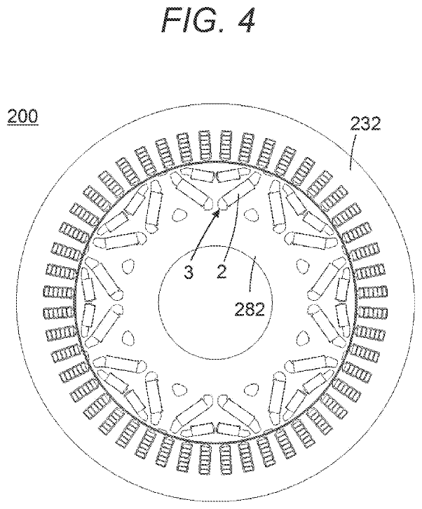

FIG. 3 is a cross-sectional view of a rotary electric machine in FIG. 1. FIG. 4 is a cross-sectional view of a rotor core and a stator core, taken along the line A-A in FIG. 3. Incidentally, the rotary electric machine 200 and the rotary electric machine 202 have substantially the same configuration and, hereinafter, the rotary electric machine 200 will be described, regarding its configuration, as a representative example. However, the configuration which will be described hereinafter is not required to be adopted in both of the rotary electric machines 200, 202, and may be adopted in only one of them. Furthermore, the stator core illustrated in FIG. 4 includes 8 poles (4 pairs of poles) and 48 slots, for example. However, the stator core is not limited thereto, and may have different numbers of slots and poles therefrom. Further, there is no limit to the number of cores, and the present invention can be applied to a stator having any number of cores.

A stator 230 is held inside a housing 212, and the stator 230 includes a stator core 232 and a stator winding 238. A rotor 280 is rotatably held near the inner periphery of the stator core 232 with a gap 222 interposed therebetween. The rotor 280 includes a rotor core 282 secured to a shaft 218, a permanent magnet 284, and cover plates 226 made of a non-magnetic material. The housing 212 has a pair of end brackets 214 provided with bearings 216, and the shaft 218 is rotatably held by these bearings 216. The rotor core 282 has magnet holes 3 as a plurality of vacancies, and a plurality of magnets 2 are inserted into portions of these magnet holes 3.

The shaft 218 is provided with a resolver 224 for detecting the positions of poles in the rotor 280 and the rotating speed of the rotor 280. An output from the resolver 224 is introduced into the control circuit 648 illustrated in FIG. 2. The control circuit 648 outputs a control signal to the drive circuit 652 based on the introduced output. The drive circuit 652 outputs drive signals based on the control signal, to the power module 610. The power module 610 performs switching operations based on the control signal, and converts DC power supplied from the battery 180 into three-phase AC power. The three-phase AC power is supplied to the stator winding 238 illustrated in FIG. 3, thereby generating a rotating magnetic field in the stator 230. The frequency of the three-phase AC current is controlled based on the value outputted from the resolver 224, and the phase of the three-phase AC current with respect to the rotor 280 is also controlled based on the value outputted from the resolver 224.

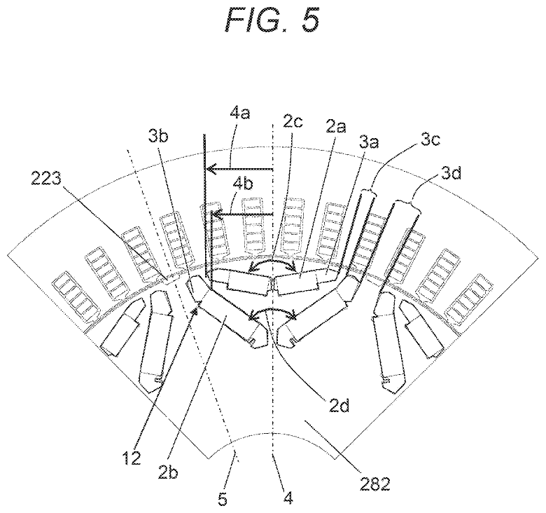

FIG. 5 is a partially enlarged view of the rotor in the rotary electric machine according to an embodiment of the present invention.

The magnets 2 inserted in the plurality of vacancies in the rotor core 282 include a pair of first magnets 2a inserted in a pair of magnet holes 3 formed in a V shape in a radially-outer side, and a pair of second magnets 2b inserted in a pair of magnet holes 3 formed in a V shape in a radially-inner side with respect to the first magnets 2a. In this arrangement of the magnets, a d-axis 4 and a q-axis 5 are defined, respectively, by a center line 4 between the pair of first magnets 2a, 2b in the same pole, and by a center line 5 between the first magnets 2a, 2b belonging to two poles adjacent to each other.

The magnet holes 3 form the combination of the two V shapes (double V shape) as described above, for the following reason. That is, as compared with a case of a single V shape, an effective portion of a gap magnetic flux density in the gap 222 is increased, while an ineffective portion thereof is decreased, which is advantageous in terms of the output torque. Therefore, by adopting the double V shape in the arrangement of the magnets in the rotor 280 as in the rotary electric machine 200 according to the present embodiment, it is possible to provide a merit that the amount and the size of magnets can be reduced as compared with a case of a conventional single V shape. However, by adopting the double V shape, the number of magnets per pole increases as compared with a case of a single V shape, which increases the torque ripple to induce pulsations in the rotation of the rotor 280, thereby inducing the problem of deterioration of the NV performance. Therefore, it is necessary to consider the positions where the magnets 2 and the magnet holes 3 are formed.

In the present invention, in the magnet holes 3 in which the first magnets 2a are inserted, there exists a vacancy at a position facing the d-axis 4 with the first magnet 2a interposed therebetween, thereby forming a first magnetic vacancy 3a. Similarly, in the magnet holes 3 in which the second magnets 2b are inserted, there exists a vacancy at a position facing the d-axis 4 with the second magnet 2b interposed therebetween, thereby forming a second magnetic vacancy 3b.

When viewed in the direction perpendicular to d-axis 4 (in the leftward and rightward direction in the figure), the distance 4a from the d-axis 4 to an end portion of the first magnetic vacancy 3a is larger than the distance 4b from the d-axis 4 to the end portion of the second magnet 2b in the outermost diameter side.

Further, in the outermost diameter side, the distance 3c between the first magnetic vacancy 3a and the second magnetic vacancy 3b is smaller than the distance 3d between the second magnetic vacancies 3b in two poles adjacent to each other. Further, the magnitude 2c of the angle inside the V shape formed by the first magnets 2a is larger than the magnitude 2d of the angle inside the V shape of the second magnets 2b.

By doing this, it is possible to suppress the leakage of the magnetic flux between the first magnetic vacancy 3a and the second magnetic vacancy 3b (the distance 3c) and the like, which can make the gap magnetic flux density sinusoidal, thereby smoothing the change of the magnetic flux. This can realize reduction of torque ripples.

Incidentally, the present invention can be implemented, even when the magnet holes 3 are not provided with a position restricting protrusion 12 for supporting the magnet 2. Further, such a position restricting protrusion 12 may be formed either in the radially inner side or the radially outer side of each magnet hole 3 or in both of them. Further, a plurality of gaps 223 formed in the outer periphery of the rotor core is formed on the q-axes 5, while no gap is provided on the d-axes 4, which provides an effect of reducing torque ripples as a whole.

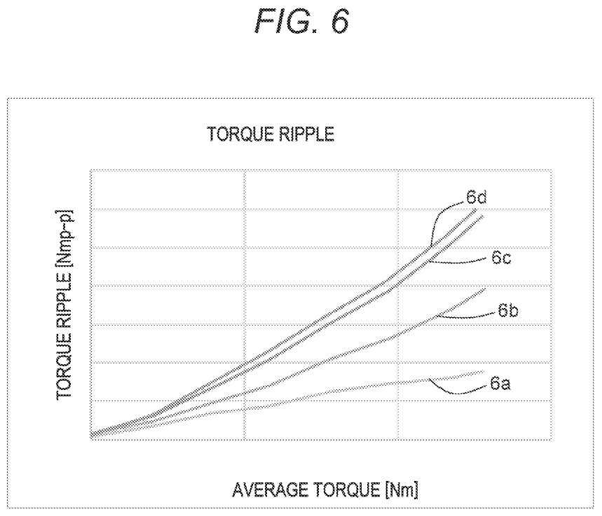

FIGS. 6 to 9 are views for explaining the effects of the invention, according to an embodiment of the present invention.

FIG. 6 expresses results s (states of torques) of verifications of the effect of 3c<3d. Incidentally, in the following verifications, 4a>4b and 2c>2d were satisfied. Four patterns were prepared for the verifications of the effect, and there are illustrated a graph 6a in a case of 3c<<3d, a graph 6b in a case of 3c<3d, a graphs 6c in a case of 3c≈3d, and a graph 6d in a case of 3c>3d. This reveals that in the cases of 3c<3d and 3c<<3d, the torque ripple was made smaller than in the case of 3c≈3d or 3c>3d. Further, this reveals that as 3c was smaller than 3d, the gap magnetic flux density was made more sinusoidal, thereby suppressing the torque ripple.

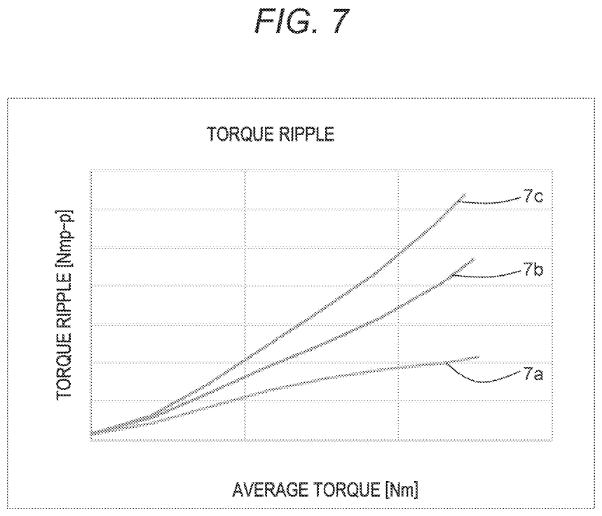

FIG. 7 illustrates three patterns, which are a graph 7a in a case of setting 3c<3d while maintaining 4a<4b, a graph 7b in a case of setting 3c≈3d while maintaining 4a<4b, and a graph 7c in a case of setting 3c>3d while maintaining 4a<4b, wherein the relationship between 3c and 3d was changed while the relationship of 4a<4b was maintained. As a result, as illustrated in FIG. 7, the graph 7c shows larger torque ripples than those in the graph 7a, which reveals that the relationship of 3c<3d is important for reducing torque ripples.

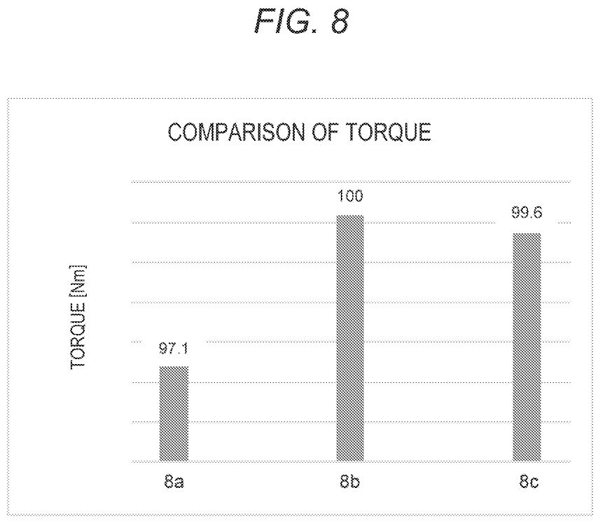

In the verifications of the effects in FIG. 8, there are illustrated three patterns, which are a bar graph 8a in a case of setting the angle 2c<the angle 2d while maintaining 4a>4b and 3c<3d, a graph 8b in a case of setting the angle 2c=the angle 2d while maintaining 4a>4b and 3c<3d, and a graph 8c in a case of setting 2c>2d while maintaining 4a>4b and 3c<3d. This reveals that unless the relationship of the angle 2c<the angle 2d holds, these angles 2c and 2d exert no such an influence as to significantly reduce the torque.

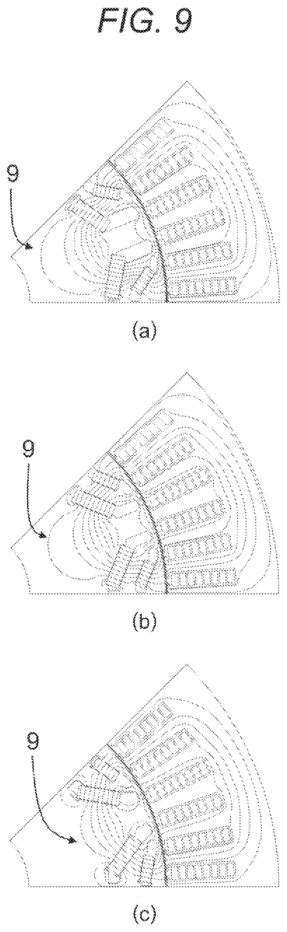

FIG. 9 is a view illustrating results of simulations about a magnetic flux in the rotor and the stator for verifying the effect of the relationship of the angle 2c>the angle 2d. FIG. 9(a) illustrates a state of a magnetic flux 9 in a case of the angle 2c<the angle 2d, FIG. 9(b) illustrates a state of a magnetic flux 9 in a case of the angle 2c≈the angle 2d, and FIG. 9(c) illustrates a state of a magnetic flux 9 in a case of the angle 2c>the angle 2d. In comparison therebetween, in FIG. 9(a), there is a wide magnetic path in an inner diameter side of the rotor, and if the rotor core portion does not exist up to this range, the torque decreases. However, as in FIG. 9(c), in a state where the range of the magnetic path is restricted in the inner diameter side of the rotor, the torque can be increased with a smaller amount of the rotor core.

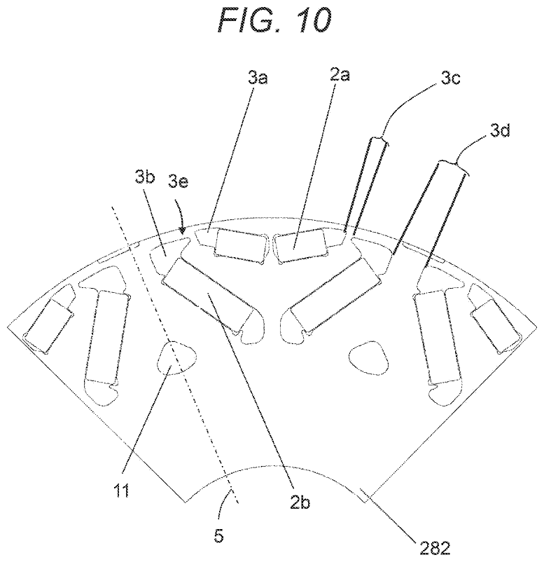

FIG. 10 is a first modification example of the present invention.

In the first modification example, a second magnetic vacancy 3b is brought closer to a first magnetic vacancy 3a at its portion (end portion) closest to the first magnetic vacancy 3a, thereby forming a convex shape 3e. By doing this, it is possible to make the distance 3c between the first magnetic vacancy 3a and the second magnetic vacancy 3b smaller, which can narrow the path of the magnetic flux, thereby realizing an effect of further reducing torque ripples. Further, there is formed a positioning hole 11 on the q-axis 5, which contributes to the reduction of the weight of the rotor core 282.

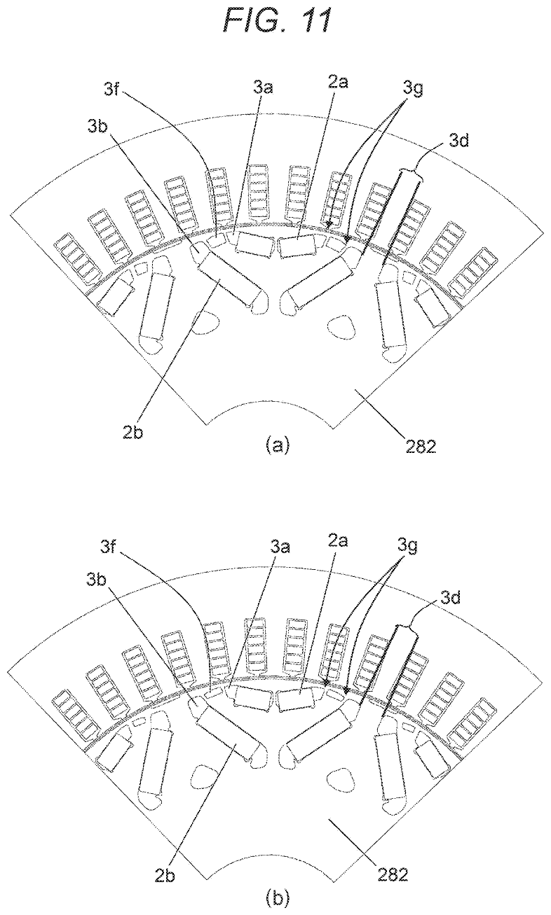

FIG. 11(a) is a second modification example of the present invention, and FIG. 11(b) is a third modification example thereof.

In the second and third modification examples, a vacancy is further provided between a first magnetic vacancy 3a and a second magnetic vacancy 3b (a third magnetic vacancy 3f). There are provided respective bridge portions 3g between the first magnetic vacancy 3a and the third magnetic vacancy 3f and between the second magnetic vacancy 3b and the third magnetic vacancy 3f. By doing this, it is possible to narrow the paths of the magnetic flux in the portions of the bridge portions 3g, thereby realizing an effect of further reducing torque ripples. Incidentally, the shape of the third magnetic vacancy 3f may be any shape provided that there are provided the bridge portions 3g.

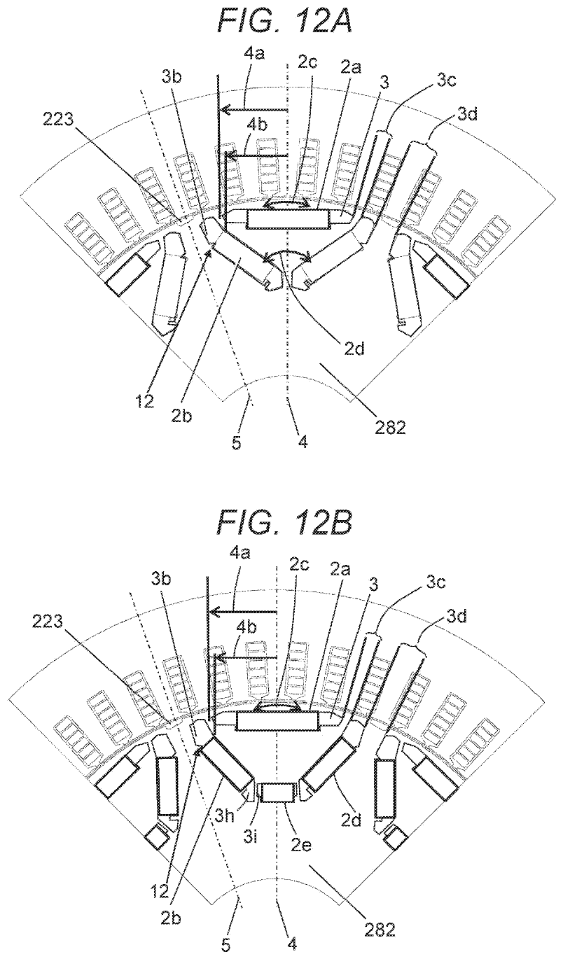

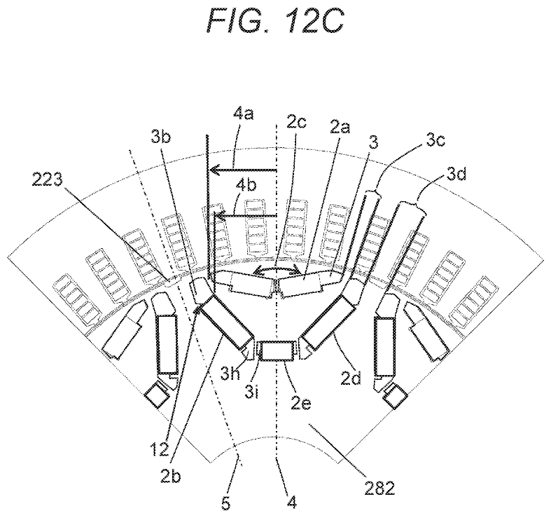

FIG. 12A is a fourth modification example of the present invention, FIG. 12B is a fifth modification example thereof, and FIG. 12C is a sixth modification example thereof.

In the fourth modification example, the first magnets 2a are not formed to have a V shape, the magnet holes 3 in which the first magnets 2a are inserted are made continuous, and the angle 2c (see FIG. 5) is set to be 180°, so that each first magnet 2a is formed to be one first magnet 2a. This can provide the same effect as that of the double V shaped arrangement of magnets 2.

Further, in the fifth modification example, a third magnet 2e is provided at a position between the magnet holes 3 in which the second magnets 2b are inserted. The third magnet 2e is inserted in a magnet hole provided with fourth magnetic vacancies 3i at its left and right end portions. Further, each second magnetic vacancy (in an inner peripheral side) 3h is provided between a fourth magnetic vacancy 3i and a second magnet 2b or a third magnet 2d. By doing this, it is possible to reduce torque ripples while enhancing the magnetic force of the rotor core 282 which is caused by the magnets 2. Incidentally, the second magnetic vacancies (in the inner peripheral side) 3h and the fourth magnetic vacancies 3i may have any shape which induces no problem in the rotational strength.

Further, as the sixth modification example, there is illustrated an example where the angle 2c in the fifth modification example is made smaller than 180° to form a V shape, which can also realize an effect of reducing torque ripples similarly to in the fifth modification example. Further, it is also possible to combine these arrangements of magnets with the arrangement of the third magnetic vacancies 3f in FIG. 11, which can also provide a similar effect.

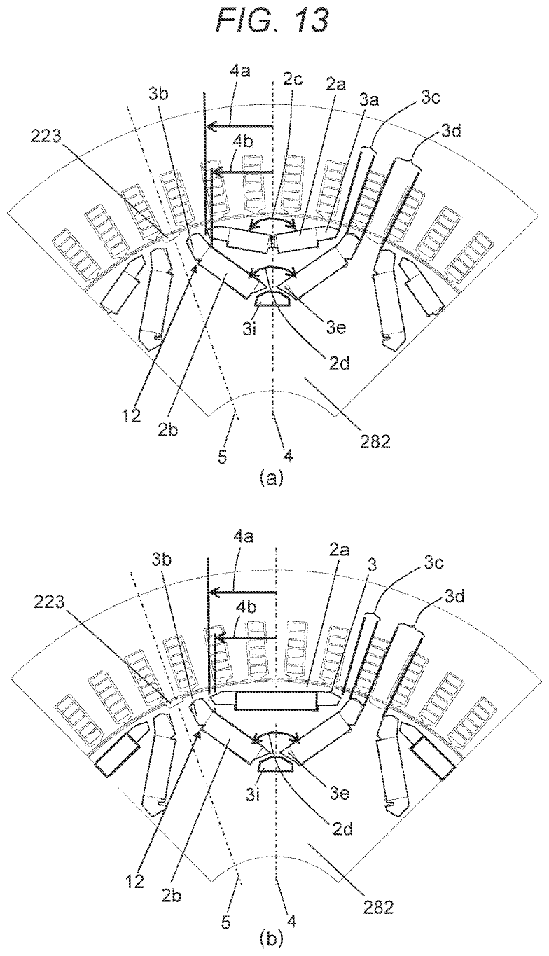

FIGS. 13(a) and 13(b) are a seventh modification example and an eighth modification example, respectively, of the present invention.

In the seventh and eighth modification examples, only a fourth magnetic vacancy 3i is provided, and no third magnet 2e is provided, at a position between magnet holes 3 in which a second magnet 2b or a third magnet 2d in FIG. 5 are inserted, and third magnetic vacancies 3e are provided at the end portions of the second magnet 2b and the third magnet 2d closer to the fourth magnetic vacancy 3i. As described above, the magnetic vacancy can be divided into plural portions for dispersing the stress, according to the rotational strength. In this case, it is also possible to provide an effect of reducing torque ripples similarly to in the other modification examples.

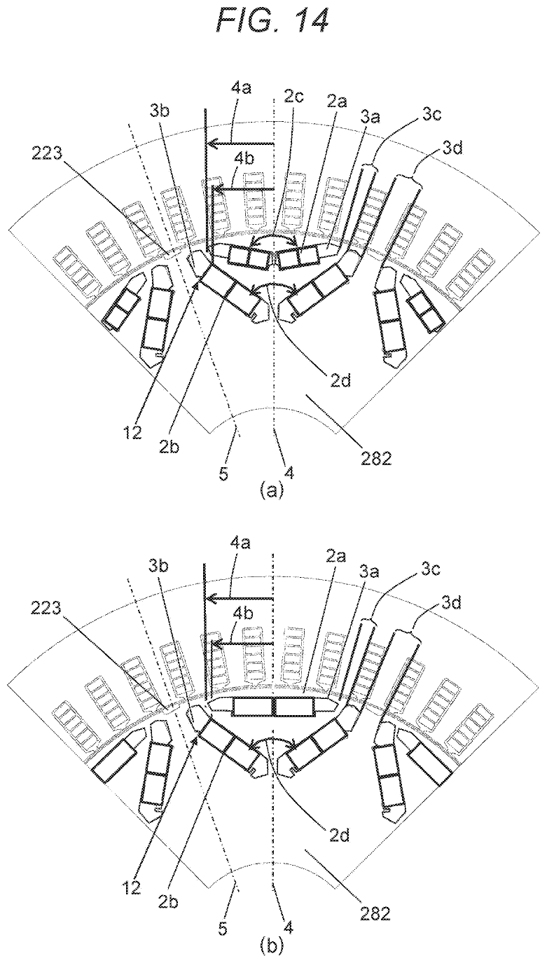

FIGS. 14(a) and 14(b) are a ninth modification example and a tenth modification example, respectively, of the present invention.

In the ninth and tenth modification examples, the first magnets 2a and the second magnets 2b in the examples used in FIGS. 5 and 12 (a) are shaped in such a way as to be divided in the direction (the axial direction) perpendicular to their respective longer sides. By doing this, it is possible to suppress heat generation in the respective magnets, which can improve their demagnetization resistance. In this case, it is also possible to provide an effect of reducing torque ripples similarly to in the other examples. Incidentally, each magnet can be also divided along a cross-section in a direction perpendicular to the axial direction (a direction parallel to the paper surface), for example. In this case, similarly, it is possible to suppress heat generation in the magnets. The magnets can be divided in any dividing manner which can secure the fixability of the magnets.

In the aforementioned examples according to the present invention, the first magnets 2a, the second magnets 2b, and the third magnets 2e may be equal to each other, in magnet characteristics such as residual magnetic flux density and coercivity. Also, the first magnets 2a, the second magnets 2b, and the third magnets 2e may be formed from different materials having respective necessary coercivities, since they receive a reverse magnetic field from the stator in respective different manners. By doing this, it is possible to reduce the cost of the magnets, which enables fabrication of the rotary electric machine with lower cost.

Further, as a method for securing the magnets, it is possible to adopt any securing methods, such as potting of an adhesive agent, securing through injection of a molding material, insertion of a sheet which is fired by being heated between the magnets and the rotor core, securing the magnets by deforming the rotor core at its portions near the magnets, and the like. In any example, it is possible to exert an effect of reducing torque ripples.

According to one embodiment of the present invention which has been described above, it is possible to provide effects and advantages as follows.
(1) A rotor 280 for a rotary electric machine 200 includes magnets 2 and magnet holes 3 in which the magnets 2 are inserted, the magnets 2 includes a pair of first magnets 2a arranged in a V shape, and a pair of second magnets 2b arranged in a V shape in a radially inner side with respect to the first magnets 2a, the magnet holes 3 are provided with a first magnetic vacancy 3a facing a d-axis 4 with a first magnet 2a interposed therebetween, and a second magnetic vacancy 3b facing the d-axis 4 with a second magnet 2b interposed therebetween. A distance from the d-axis 4 to an end portion of the first magnetic vacancy 3a is made larger than a distance from the d-axis 4 to an end portion of the second magnet 2b in an outermost diameter side when viewed in a direction perpendicular to the d-axis 4. In an outermost diameter side, a distance between the first magnetic vacancy and the second magnetic vacancy 3b is smaller than a distance between the second magnetic vacancies 3b adjacent to each other in a plurality of magnetic poles. The V-shape formed by the pair of first magnets 2a has an inside angle with a magnitude 2c which is larger than a magnitude 2d of an inside angle of the V-shape formed by the pair of second magnets 2b. By doing this, it is possible to provide a rotor for a rotary electric machine capable of generating higher outputs while reducing torque ripples.
(2) In the rotor core 282, the magnet holes 3 in which the first magnets 2a are inserted are formed continuously with the d-axis 4 interposed therebetween, and the pair of first magnets 2a is formed continuously. By doing this, it is possible to reduce the number of magnets 2 mounted thereon, which enables simplification of the shape.
(3) In the rotor core 282, a vacancy is formed between the first magnetic vacancy 3a and the second magnetic vacancy 3b. By doing this, it is possible to realize an effect of further reducing torque ripples.
(4) In the rotor core 282, a third magnet 2e is provided at a position between the magnet holes 3 in which the pair of second magnets 2b is inserted. This can further reduce torque ripples while enhancing the magnetic force of the rotor core 282.
(5) A rotary electric machine includes the rotor for a rotary electric machine according to the embodiment of the present invention. By doing this, it is possible to provide a rotary electric machine capable of generating higher outputs while reducing torque ripples.

Incidentally, the present invention is not limited to the aforementioned embodiment, and various modifications and other structures can be combined therewith without departing from the gist of the present invention. Further, the present invention is not limited to structures including all the structures described in the aforementioned embodiment, and also includes structures provided by eliminating some of these structures.

### REFERENCE SIGNS LIST

2 rotor magnet
2a first magnet
2b second magnet
2c magnitude of inside angle of V shape of first magnets
2d magnitude of inside angle of V shape of second magnets
2e third magnet
3 magnet hole
3a first magnetic vacancy
3b second magnetic vacancy
3c distance between first magnetic vacancy and second magnetic vacancy
3d distance between adjacent second magnetic vacancies
3e convex shape of second magnetic vacancy
3f third magnetic vacancy
3g bridge portion of third magnetic vacancy
3h second magnetic vacancy (in inner peripheral side)
3i fourth magnetic vacancy
4 d-axis
4a distance from d-axis to farthest point of first magnetic vacancy
4b distance to corner portion of second magnet facing radially outer side
5 q-axis
100 vehicle
200 rotary electric machine
280 rotor
282 rotor core
600 power conversion device

1. A rotor for a rotary electric machine, the rotor comprising magnets and magnet holes in which the magnets are inserted, wherein
the magnets include a pair of first magnets arranged in a V shape, and a pair of second magnets arranged in a V shape in a radially inner side with respect to the first magnets,
the magnet holes are provided with a first magnetic vacancy facing a d-axis with the first magnet interposed therebetween, and a second magnetic vacancy facing the d-axis with the second magnet interposed therebetween,
a distance from the d-axis to an end portion of the first magnetic vacancy is made larger than a distance from the d-axis to an end portion of the second magnet in an outermost diameter side when viewed in a direction perpendicular to the d-axis,
in an outermost diameter side, a distance between the first magnetic vacancy and the second magnetic vacancy is smaller than a distance between the second magnetic vacancies adjacent to each other in a plurality of magnetic poles, and
the V-shape formed by the pair of first magnets has an inside angle with a magnitude which is larger than a magnitude of an inside angle of the V-shape formed by the pair of second magnets.

2. The rotor for a rotary electric machine according to claim 1, wherein
the magnet holes in which the first magnets are inserted are formed continuously with the d-axis interposed therebetween, and
the pair of first magnets is formed continuously.

3. The rotor for a rotary electric machine according to claim 1, wherein a vacancy is formed between the first magnetic vacancy and the second magnetic vacancy.

4. The rotor for a rotary electric machine according to claim 1, wherein a third magnet is provided at a position between the magnet holes in which the pair of second magnets is inserted.

5. A rotary electric machine comprising the rotor for a rotary electric machine according to claim 1.
